(19) United States
(12) Patent Application Publication
(10) Pub. No.: US 2015/0046688 A1
(43) Pub. Date: Feb. 12, 2015

(54) METHOD OF GENERATING PROCESSOR TEST INSTRUCTION SEQUENCE AND GENERATING APPARATUS

(71) Applicant: FUJITSU LIMITED, Kawasaki-shi (JP)

(72) Inventor: TAMORU INOUE, Kawasaki (JP)

(21) Appl. No.: 14/322,020

(22) Filed: Jul. 2, 2014

(30) Foreign Application Priority Data
Aug. 12, 2013 (JP) 2013-167501

(51) Int. Cl. G06F 9/30

(52) U.S. Cl. CPC G06F 9/30098
USPC 712/227

(57) ABSTRACT

A test instruction sequence generating method for a processor includes classifying registers used for executing test instructions into two register groups, generating a test instruction executed by the processor, amending a register specified in a result value register field of the test instruction to a register of a first register group when a first instruction is specified in an arithmetic type field of the test instruction and a register of a second register group is specified in the result value register field of the test instruction, and further amending a register specified in a input value register field of the test instruction to a register of the second register group when a second instruction is specified in the arithmetic type field of the test instruction and a register of the first register group is specified in the input value register field of the test instruction.

### CROSS-REFERENCE TO RELATED APPLICATION

This application is based upon and claims the benefit of priority of the prior Japanese Patent Application No. 2013-167501, filed on Aug. 12, 2013, the entire contents of which are incorporated herein by reference.

### FIELD

The present invention relates to a method of generating a test instruction sequence for a processor and a generating apparatus.

### BACKGROUND

In recent years, acceleration of processing speed of a processor has involved using a method termed an SIMD (Single Instruction Multiple Data) instruction, in which plural pieces of data are processed by a single instruction.

In a conventional test of the processor, such a case arises that designation of a register is determined by random numbers in generating a random instruction sequence, and hence a value of the register not used for an arithmetic operation but used for outputting a result value becomes an indefinite value due to a normal instruction, e.g., an SISD (Single Instruction Single Data) instruction different from the SIMD instruction.

### DOCUMENTS OF PRIOR ARTS

### Patent Document

[Patent document 1] Japanese National Publication of International Patent Application No. 2002-527823
[Patent document 2] Japanese Laid-Open Patent Publication No. 2000-181741

### SUMMARY

According to one aspect of a method, a processor test instruction sequence generating method is provided. The processor test instruction sequence generating method includes classifying registers used for executing test instructions into two register groups, allocating a register of a first register group to a first instruction to make at least a value of a second register an indefinite value when rewriting a first register, allocating a registers of a second register group to a second instruction to access a plurality of registers when performing a single execution, and thus dividing the registers, generating a test instruction, and amending the specified register corresponding to an arithmetic type field.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrating one example of a configuration of a register;

FIG. 2 is a diagram illustrating an example of the register used for an SIMD instruction;

FIG. 3 is a diagram illustrating an example of the register used for an SISD instruction;

FIG. 4 is a diagram illustrating a usage example of registers of which values are not ensured;

FIG. 5 is a diagram of hardware architecture of a test instruction sequence generating apparatus in an example 1;

FIG. 6 is a diagram of functional blocks of the test instruction sequence generating apparatus in the example 1;

FIG. 7 is a diagram illustrating one example of register dividing information;

FIG. 8 is a diagram illustrating a data structure of a register dividing table in a case where a division count is “2” and a start register arithmetic type is an SISD arithmetic operation;

FIG. 9 is a diagram illustrating a data structure of the register dividing table in a case where the division count is “4” and the start register arithmetic type is an SIMD arithmetic operation;

FIG. 10 is a diagram illustrating one example of definitions of fields of a test instruction;

FIG. 11 is a flowchart depicting a processing procedure of generating a test instruction sequence of a control program in the example 1;

FIG. 12 is a flowchart depicting a processing procedure of generating the test instruction sequence of the control program in an example 2;

FIG. 13 is a diagram of functional blocks of an information processing apparatus in an example 3;

FIG. 14 is a flowchart depicting a test processing procedure of the control program in the example 3;

FIG. 15 is a diagram of hardware architecture of the information processing apparatus in a modified example of the example 3; and

FIG. 16 is a diagram of functional blocks of the information processing apparatus in the modified example of the example 3.

### DESCRIPTION OF EMBODIMENTS

In the conventional test for the processor, if the test is performed by an instruction sequence containing SISD instructions and SIMD instructions in mixture, the value of the register not used for the arithmetic operation but used for outputting the result value in the SISD instruction becomes the indefinite value, resulting in a case where an execution result of the instruction sequence cannot be verified.

An embodiment of the present invention will hereinafter be described based on the drawings. A configuration of the following embodiment is an exemplification, and the present invention is not limited to the configuration of the embodiment.

### First Working Example

### Hardware Architecture

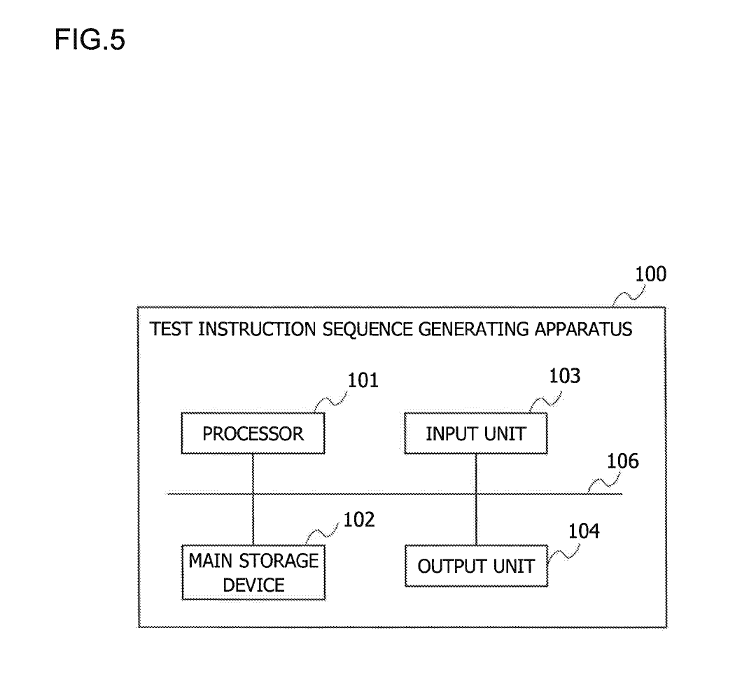

FIG. 5 is a diagram of hardware architecture of a test instruction sequence generating apparatus in a first working example (example 1). In the example 1, a test instruction sequence generating apparatus 100 generates a test instruction sequence for a processor 101 included in the apparatus itself. Further, the processor 101 defined as a test target device is a processor capable of executing an SISD instruction and an SIMD instruction. The SISD instruction is one example of a first instruction, while the SIMD instruction is one example of a second instruction.

In FIG. 5, the test instruction sequence generating apparatus 100 includes the processor 101, a main storage device 102, an input unit 103 and an output unit 104, which are connected to each other via a bus 106.

A control program 10 for generating a test instruction sequence is stored in the main storage device 102. The processor 101 reads the control program 10 from the main storage device 102 and executes this readout program. Note that the control program 10 may not be stored in the main storage device 102. For example, the control program 10 can be stored on a portable recording medium such as a CD-ROM (Compact Disc Read Only Memory), a DVD (Digital Versatile Disc) and a USB (Universal Serial Bus) memory. The test instruction sequence generating apparatus 100 may read the control program 10 from the portable recording medium and may execute the readout program.

The processor 101 can receive information used for determining whether generation of the instruction sequence is completed or not, from the input unit 103. Further, the processor 101 outputs the generated instruction sequence and a test execution result to the output unit 104. The output unit 104 can write the test instruction sequence, which is output from the processor 101, to the auxiliary storage unit and the portable recording medium and can display the test instruction sequence on a liquid crystal display etc.

<Configuration of Register>

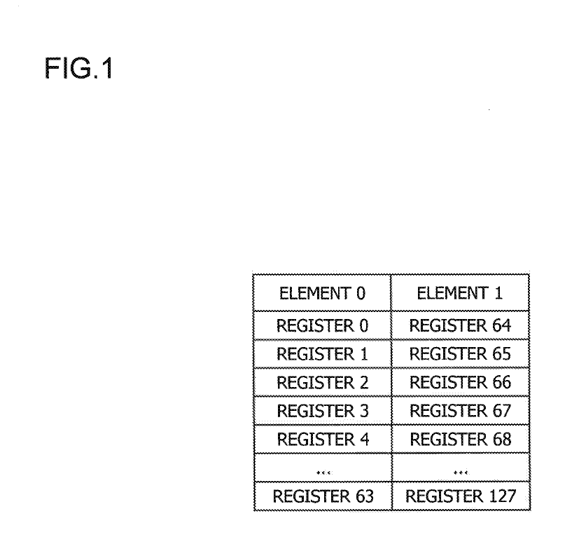

FIG. 1 illustrates registers included in the processor 101, the registers being classified into two categories. In the example 1, the registers included in the processor 101 are configured to have the two categories, e.g., an element 0 and an element 1. In FIG. 1, the element 0 contains register 0 through a register 63, while the element 1 contains a register 64 through a register 127.

The processor 101 uses, with respect to the SIMD instruction, the registers 0-63 belonging to the element 0 and the registers 64-127 belonging to the element 1 in parallel. Herein, a phrase “using in parallel” connotes that when executing one SIMD instruction, for example, inputs are given from a plurality of registers storing input values, and outputs are given to a plurality of registers to store result values, respectively. Hereinafter, the register storing the input value is called an “input value register”, while the register to store the result value is called a “result value register”. Moreover, the plural input value registers accessed in parallel, with one SIMD instruction being executed, are called “associative input value registers”. Similarly, the plural output registers to which the result values are output in parallel, with one SIMD instruction being executed, are called “associative result value registers”.

On the other hand, with respect to the SISD instruction, the processor 101 uses the registers 0-63 belonging to the element 0 but does not use the registers 64-127 belonging to the element 1.

Note that the registers belonging to the element 0 are one example of first registers, and the registers belonging to the element 1 are one example of second registers. Further, arithmetic operations performed by the processor 101 executing the SISD instruction and the SIMD instruction are termed an SISD arithmetic operation and an SIMD arithmetic operation, respectively.

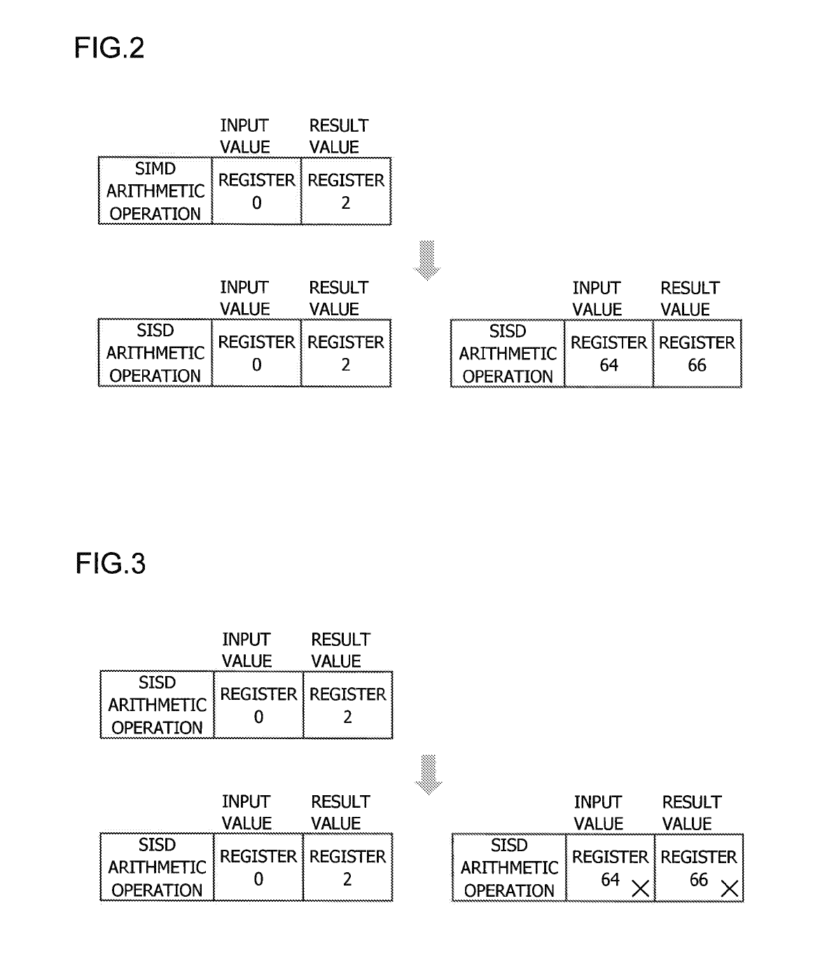

FIGS. 2 through 4 illustrate relationships between types of the arithmetic operations of the test instructions, the input value registers and the result value registers.

FIG. 2 illustrates the registers used for the SIMD instruction. In FIG. 2, the processor 101 uses the register 0 of the element 0 as the input value register and the register 2 of the element 0 as the result value register for executing the SIMD instruction. Further on the occasion of executing the SIMD instruction, the processor 101 uses the register 64 of the element 1 as the input value register associated with the register 0 of the element 0. Moreover, the processor 101 uses the register 66 of the element 1 as the result value register associated with the register 2 of the element 0.

FIG. 3 depicts an example of the registers used for the SISD instruction. In FIG. 3, the processor 101 uses the register 0 of the element 0 as the input value register and the register 2 of the element 0 as the result value register for executing the SISD instruction. In this case, the processor 101 employs neither the register 64 of the element 1 defined as the input value register associated with the register 0 of the element 0 nor the register 66 of the element 1 as the result value register associated with the register 2 of the element 0. The processor 101 in the example 1 uses one of the plurality of associative registers for the SISD instruction, in which case a value of another associative register becomes an indefinite value. Therefore, when the processor 101 uses the register 2 of the element 0 as the result value register for the SISD instruction, a value of the register 66 of the element 1 as the associative result value register becomes the indefinite value.

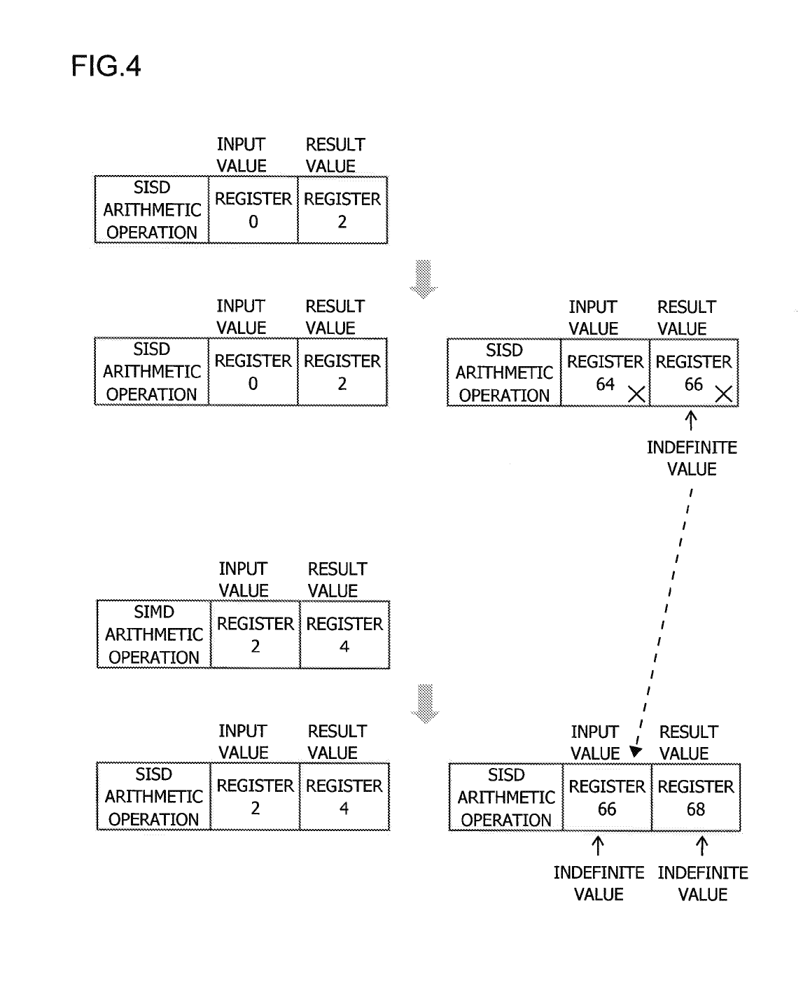

FIG. 4 illustrates an example of how the registers are employed in such a case that the values of the registers are not ensured in the register configuration in FIG. 1. Similarly to the case in FIG. 3, the processor 101 uses the register 0 of the element 0 as the input value register and the register 2 of the element 0 as the result value register for executing the SISD instruction. In this instance, the processor 101 employs neither the register 64 of the element 1 defined as the input value register associated with the register 0 of the element 0 nor the register 66 of the element 1 as the result value register associated with the register 2 of the element 0. Hence, when the processor 101 uses the register 2 of the element 0 as the result value register for the SISD instruction, a value of the register 66 of the element 1 as the associative result value register becomes the indefinite value.

Herein, such a case is considered that the SIMD instruction is executed next to the SISD instruction. FIG. 4 illustrates an example of the SIMD instruction next to the SISD instruction, the SIMD instruction involving the use of the register 2 of the element 0 as the input value register and the use of the register 4 of the element 0 as the result value register. As illustrated in FIG. 1, the register 66 of the element 1 is associated with the register 2 of the element 0, and the register 68 of the element 1 is associated with the register 4 of the element 0. Accordingly, when using the register 2 of the element 0 as the input value register and the register 4 of the element 0 as the result value register, it follows that the SIMD instruction involving the use of the register 66 as the input value register and the use of the register 68 as the result value register, is also executed in parallel. In this instance, the value of the register 66 becomes the indefinite value due to the execution of the SISD instruction, and hence the value of the register 68 outputting the result value also becomes the indefinite value. Namely, the result value register with its value becoming the indefinite value due to the execution of the SISD instruction is used as the input value register for the SIMD instruction, in which case the value of the register of the element 1 used as the result value register for the SIMD instruction cannot be ensured.

The example 1 is contrived not to use the register, with its value becoming the indefinite value due to the execution of the SISD instruction, as the input value register for the SIMD instruction. For instance, the processor 101 classifies the plurality of registers into two groups, i.e., a register group for the SISD arithmetic operation and a register group for the SIMD arithmetic operation. The register group for the SISD arithmetic operation is one example of a first register group, and the register group for the SIMD arithmetic operation is one example of a second register group.

The processor 101 employs, on the occasion of executing the SISD instruction, the registers classified as the register group for the SISD arithmetic operation. Further, the processor 101 uses, on the occasion of executing the SIMD instruction, the registers classified as the register group for the SIMD arithmetic operation. In the example 1, the processor 101 amends, when generating the test instruction sequence, the input value registers and the result value registers used for executing the instructions to the registers corresponding to the types of the arithmetic operations.

<Functional Blocks of Test Instruction Sequence Generating Apparatus>

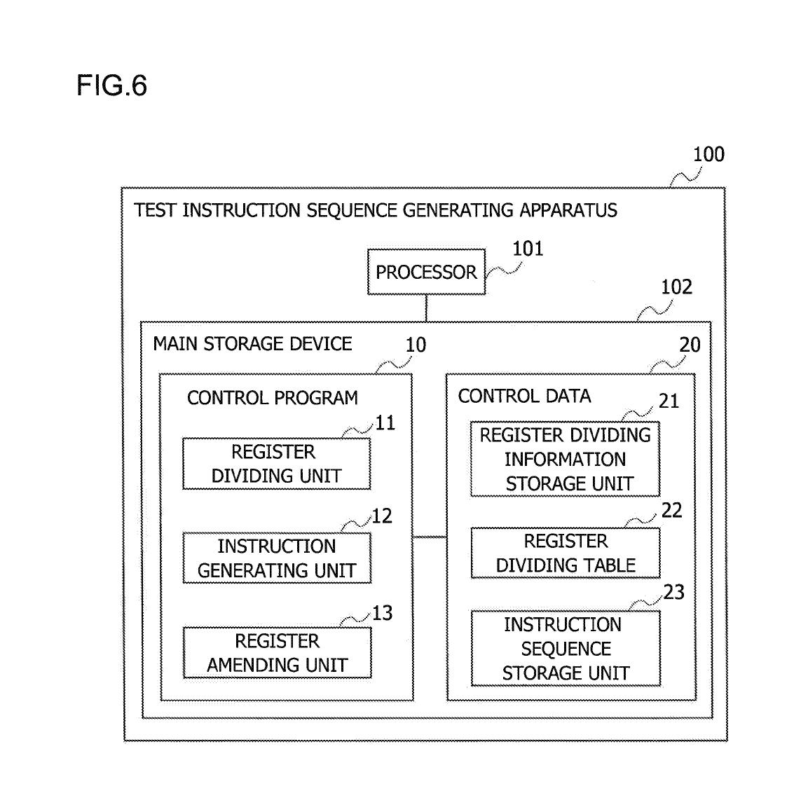

FIG. 6 is a diagram of functional blocks of the test instruction sequence generating apparatus in the example 1. In FIG. 6, the test instruction sequence generating apparatus 100 is an apparatus to generate the test instruction sequence for the processor 101 included in the apparatus itself, and includes the processor 101 and the main storage device 102.

The main storage device 102 stores a control program 10 and control data 20. The control program 10 has program modules functioning as a register dividing unit 11, an instruction generating unit 12 and a register amending unit 13. The program modules are also called sub-programs. Any one or more of the register dividing unit 11, the instruction generating unit 12 and the register amending unit 13 may be realized by hardware circuits, dedicated LSIs, etc. The control data 20 has storage areas used for a register dividing information storage unit 21, a register dividing table 22 and an instruction sequence storage unit 23.

The register dividing unit 11 generates the register dividing table 22 on the basis of register dividing information acquired from the register dividing information storage unit 21 and a register count of the processor 101.

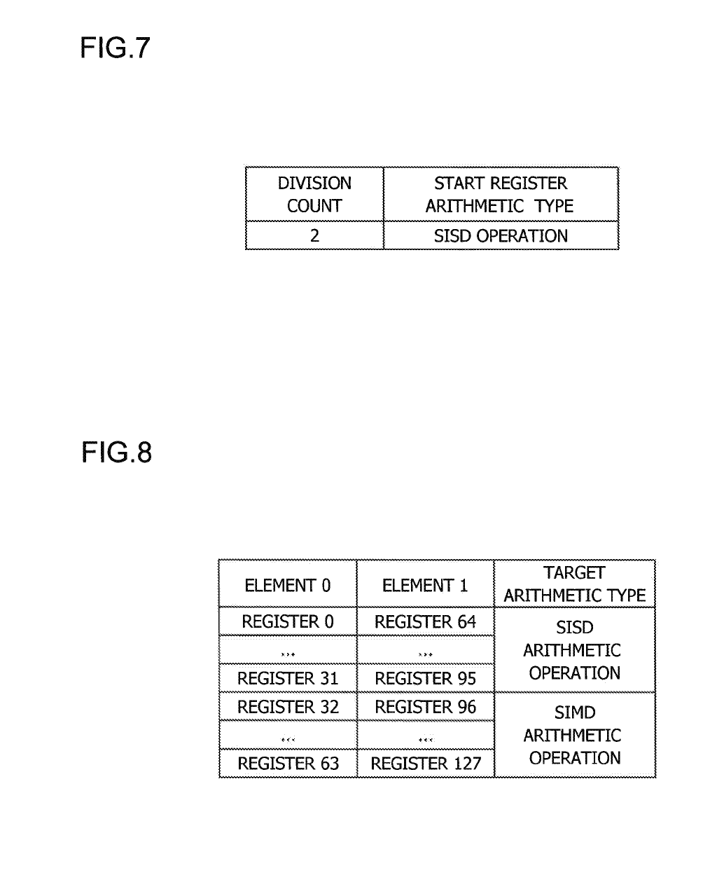

FIG. 7 illustrates a structure of the register dividing information. The register dividing information contains a “division count” and a “start register arithmetic type”.

The “division count” is a value for defining what number the entire registers are divided by, in which if the entire registers of the test target processor count up to, e.g., “64”, the division count takes values such as 2, 4, 8, 16 and 32. Herein, the registers 0-32 of the entire registers belong to the element 0, and the registers 33-63 thereof belong to the element 1. When the “division count” is 4, the register dividing unit 11 divides the entire registers into 4 register subgroups. Each register subgroup contains 16 registers. Further, the registers of the element 0 and the associative registers of the element 1 are contained in the same register subgroup. To be specific, the register dividing unit 11 divides the entire registers into the 4 register subgroups, i.e., a first register subgroup (1) containing the registers 0-7 of the element 0 and the associative registers 32-39 of the element 1, a second register subgroup (2) containing the registers 8-15 of the element 0 and the associative registers 40-47 of the element 1, a third register subgroup (3) containing the registers 16-23 of the element 0 and the associative registers 48-55 of the element 1, and a fourth register subgroup (4) containing the registers 24-31 of the element 0 and the associative registers 56-63 of the element 1. The register dividing unit 11 classifies the odd-numbered register subgroups, i.e., the first and third register subgroups (1), (3) of the four register subgroups into a first register group. Further, the register dividing unit 11 classifies the even-numbered register subgroups, i.e., the first and third register subgroups (2), (4) of the four register subgroups into a second register group.

Namely, the register dividing unit 11 at first divides the entire registers by the “division count” into a specified number of register subgroups. Subsequently, the register dividing unit 11 classifies the odd-numbered register subgroups into the first register group and the even-numbered register subgroups into the second register group. As a result, the registers belonging to the odd-numbered register subgroups are classified into the first register group, while the registers belonging to the even-numbered register subgroups into the second register group.

The “start register arithmetic type” defines which arithmetic type, the SISD arithmetic operation or the SIMD arithmetic operation, the first register group containing the post-dividing registers is allocated to. The register dividing unit 11, when the first register group is allocated to the SISD arithmetic operation, allocates the second register group to the SIMD arithmetic operation. Moreover, the register dividing unit 11, when the first register group is allocated to the SIMD arithmetic operation, allocates the second register group to the SISD arithmetic operation.

FIG. 8 illustrates an example of the register dividing table 22 given in a case where the number of the entire registers of the processor 101 is “128”, the element 0 includes the registers 0-63, the element 1 includes the registers 64-127, the “division count” of the register dividing information is “2”, and the “start register arithmetic type” is the SISD arithmetic operation.

In this example, the register dividing unit 11 generates the register dividing table 22 as below. The register dividing unit 11 divides the entire registers into two register subgroups, i.e., a first register subgroup (1) containing the registers 0-31 of the element 0 and the associative registers 64-95 of the element 1, and a second register subgroup (2) containing the registers 32-63 of the element 0 and the associative registers 96-127 of the element 1. Next, the register dividing unit 11 classifies the odd-numbered register subgroup (1) into the first register group and the even-numbered register subgroup (2) into the second register group. The register dividing unit 11 allocates the first register group to the SISD arithmetic operation and the second register group to the SIMD arithmetic operation, thus finishing generating the register dividing table 22.

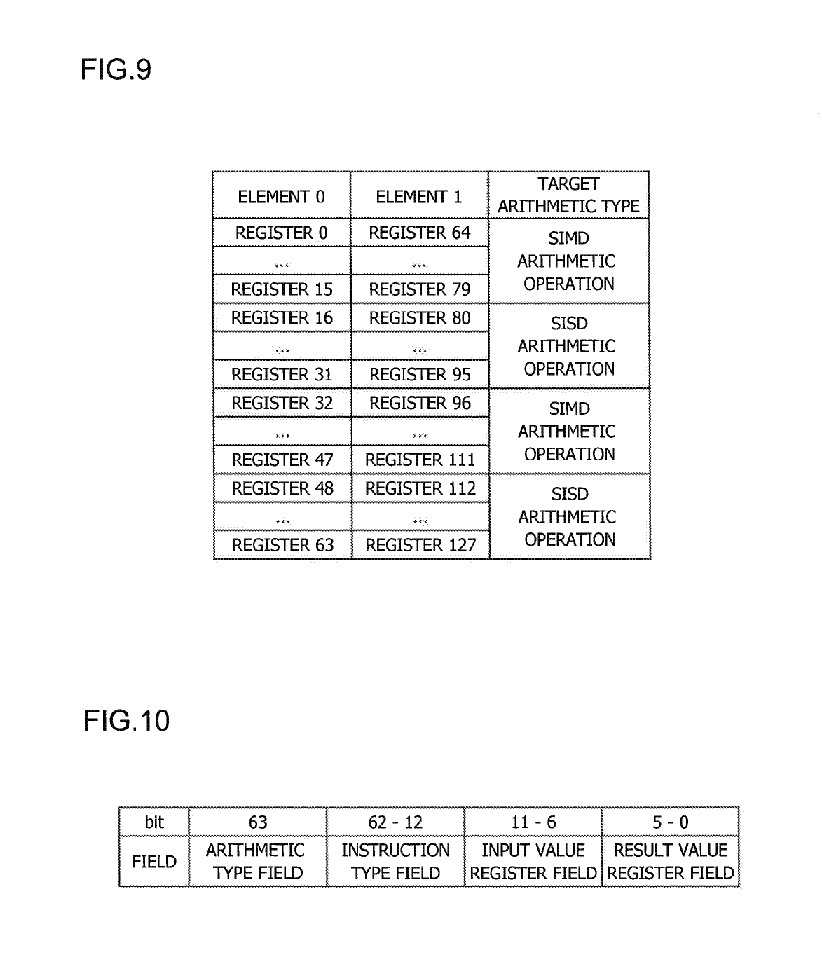

FIG. 9 depicts an example of the register dividing table 22 given in such a case that the number of the entire registers of the processor 101 is “128”, the element 0 includes the registers 0-63, the element 1 includes the registers 64-127, the “division count” of the register dividing information is “4”, and the “start register arithmetic type” is the SIMD arithmetic operation.

In this example, the register dividing unit 11 generates the register dividing table 22 in the following manner. The register dividing unit 11 divides the entire registers into four register subgroups, i.e., a first register subgroup (1) containing the registers 0-15 of the element 0 and the associative registers 64-79 of the element 1, a second register subgroup (2) containing the registers 16-31 of the element 0 and the associative registers 80-95 of the element 1, a third register subgroup (3) containing the registers 32-47 of the element 0 and the associative registers 96-111 of the element 1, and a fourth register subgroup (4) containing the registers 48-63 of the element 0 and the associative registers 112-127 of the element 1. The register dividing unit 11 classifies the odd-numbered register subgroups (1), (3) of the four register subgroups into the first register group. Further, the register dividing unit 11 classifies the even-numbered register subgroups (2), (4) of the four register subgroups into the second register group. The register dividing unit 11 allocates the first register group to the SIMD arithmetic operation and the second register group to the SISD arithmetic operation, thus finishing the generation of the register dividing table 22.

The instruction generating unit 12 generates and stores the test instructions in the instruction sequence storage unit 23. If generating the instructions by use of random number data, the instruction generating unit 12 performs the following processes by employing AND data and OR data defined per instruction type in order not to become undefined instructions. The instruction generating unit 12 clears a specified bit of the random number data by performing an AND operation with the AND data. Next, the instruction generating unit 12 sets the specified bit of this result data to “1” by conducting an OR operation with the OR data.

FIG. 10 illustrates definitions of fields of the test instruction generated by the instruction generating unit 12. The test instruction has an “arithmetic type field”, an “instruction type field”, an “input value register field”, and a “result value register field”. The “arithmetic type field” indicates a type of the SISD arithmetic operation or the SIMD arithmetic operation by using a high-order 1 bit (e.g., a 63rd bit) of the test instruction. The “instruction type field” indicates a type of the instruction determined based on specifications of the processor 101 by employing, e.g., a 62nd bit through a 12th bit of the test instruction. The “input value register field” specifies the register storing the input value for the arithmetic operation by using, e.g., an 11th bit through a 6th bit of the test instruction. The “result value register field” specifies the register to store the result value of the arithmetic operation by use of, e.g., a 5th bit through a 0th bit of the test instruction. Namely, the processor 101 uses a value of the register specified in the “input value register field” as an input value on the occasion of executing the test instruction. Moreover, the processor 101 writes a result acquired by executing the test instruction to the register specified in the “result value register field”.

The register amending unit 13 executes the following processes in accordance with the arithmetic type, which is given in the “arithmetic type field” of the test instruction.

(1) Amendment with Arithmetic Type Being SIMD Arithmetic Operation;

When the SIMD arithmetic operation is specified in the “arithmetic type field”, the register amending unit 13 amends the “input value register field”.

Note that even when the register specified in the “result value register field” is the register classified into the register group for the SISD arithmetic operation, the value of the result value register is overwritten, and hence the processor 101 can carry out a normal process. Even when the register specified in the “result value register field” is the register for the SISD arithmetic operation, the register amending unit 13 may not therefore amend the “result value register field”. For simplifying a verifying process, however, it is also feasible to verify a result of executing the test instruction sequence with respect to the registers of the element 0 but not to verify a result of executing the test instruction sequence with respect to the registers of the element 1, these registers being allocated to the SISD arithmetic operation. In this case, if the SIMD arithmetic operation is specified in the “arithmetic type field”, it is desirable for verifying the result of executing the SIMD instruction to amend also the result value registers together with the “input value register field”.

To begin with, the register amending unit 13 determines whether to amend the “input value register field” or not. The register amending unit 13 checks the input value register specified in the “input value register field” against a “target arithmetic type” in the register dividing table 22. When the test instruction is the SIMD instruction and the input value register is classified into the register group for the SISD arithmetic operation, the register amending unit 13 amends the input value register to the register classified into the register group for the SIMD arithmetic operation. Note that when the test instruction is the SIMD instruction and the input value registers are classified into the register group for the SIMD arithmetic operation, the register amending unit 13 amends nothing.

The register amending unit 13 can amend the register by the following method. For example, such a case will be described that the “division count” of the register dividing information in FIG. 8 is “2”. In the case of using a 11th bit through a 6th bit for the “input value register field” of the test instruction and specifying the register 0 in FIG. 8, the register amending unit 13 can make the amendment to specify the register 32 by inverting the 11th bit. Namely, if the “division count” of the register dividing information is “2”, the register amending unit 13 can amend the register to the register for the SIMD arithmetic operation by inverting the 11th bit. Similarly, the register amending unit 13 can amend the register to the register for the SIMD arithmetic operation by inverting the 10th bit if the “division count” is “4” and the 9th bit if the “division count” is “8”.

The following processes are executed when amending the “result value register field”.

To start with, the register amending unit 13 determines whether to amend the “result value register field” or not. The register amending unit 13 checks the result value register specified in the “result value register field” against the “target arithmetic type” in the register dividing table 22. When the test instruction is the SIMD instruction and the result value register is classified into the register group for the SISD arithmetic operation, the register amending unit 13 amends the result value register to the register classified into the register group for the SIMD arithmetic operation. Note that when the test instruction is the SIMD instruction and the result value registers are classified into the register group for the SIMD arithmetic operation, the register amending unit 13 amends nothing.

The register amending unit 13 can amend the registers by the method that follows. For instance, such a case will be described that the “division count” of the register dividing information in FIG. 8 is “2”. In the case of using a 5th bit through a 0th bit for the “result value register field” of the test instruction and specifying the register 31 in FIG. 8, the register amending unit 13 can make the amendment to specify the register 63 by inverting the 5th bit. Namely, if the “division count” of the register dividing information is “2”, the register amending unit 13 can amend the register to the register for the SIMD arithmetic operation by inverting the 5th bit. Similarly, the register amending unit 13 can amend the register to the register for the SIMD arithmetic operation by inverting the 4th bit if the “division count” is “4” and the 3rd bit if the “division count” is “8”.

(2) Amendment with Arithmetic Type Being SISD Arithmetic Operation;

When the SISD arithmetic operation is specified in the “arithmetic type field”, the register amending unit 13 amends the “result value register field”. It is to be noted that even when the register specified in the “input value register field” is the register for the SIMD arithmetic operation, the processor 101 can perform the normal processes. The register amending unit 13 may not therefore amend the “input value register field” even when the register specified in the “input value register field” is the register for the SIMD arithmetic operation.

At first, the register amending unit 13 determines whether to amend the “result value register field” or not. The register amending unit 13 checks the result value register specified in the “result value register field” against a “target arithmetic type” in the register dividing table 22. When the test instruction is the SISD instruction and the result value register is classified into the register group for the SIMD arithmetic operation, the register amending unit 13 amends the result value register to the register classified into the register group for the SISD arithmetic operation. Note that when the test instruction is the SISD instruction and the result value registers are classified into the register group for the SISD arithmetic operation, the register amending unit 13 amends nothing.

The register amending unit 13 can amend the register by the following method. For example, such a case will be described that the “division count” of the register dividing information in FIG. 8 is “2”. In the case of using a 5th bit through a 0th bit for the “result value register field” of the test instruction and specifying the register 32 in FIG. 8, the register amending unit 13 can make the amendment to specify the register 0 by inverting the 5th bit. That is, if the “division count” of the register dividing information is “2”, the register amending unit 13 can amend the register to the register for the SISD arithmetic operation by inverting the 5th bit. Similarly, the register amending unit 13 can amend the register to the register for the SISD arithmetic operation by inverting the 4th bit if the “division count” is “4” and the 3rd bit if the “division count” is “8”.

<Processing Flow>

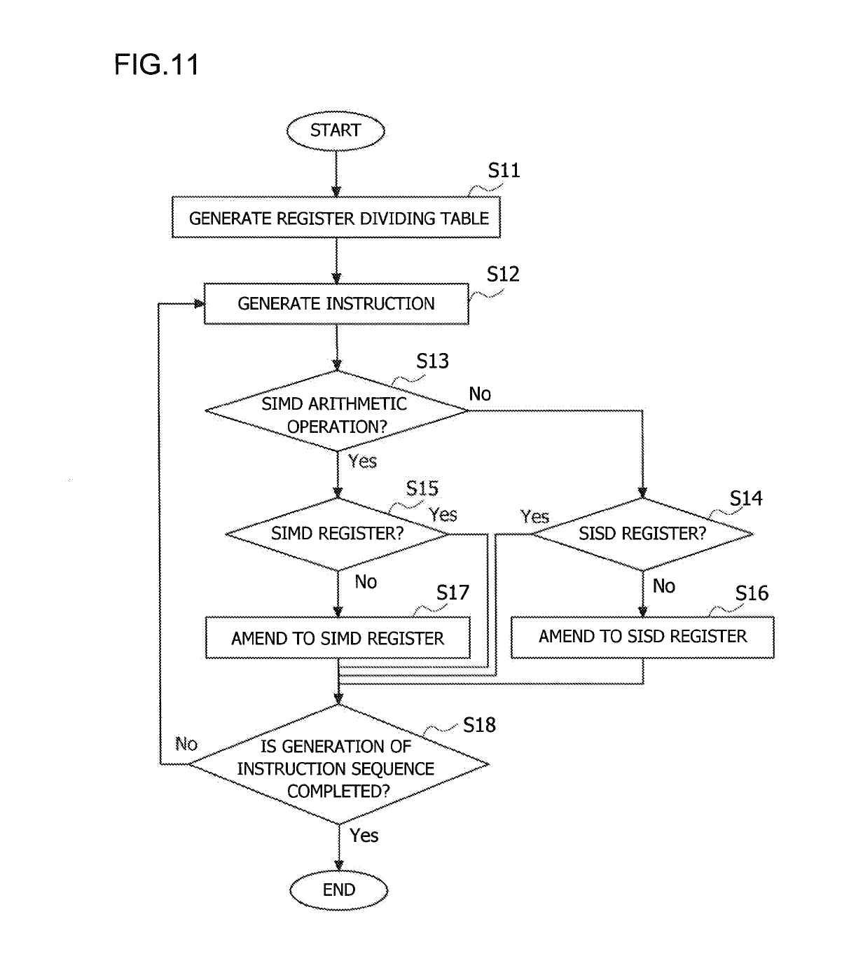

FIG. 11 is a flowchart illustrating a processing procedure of generating the test instruction sequence of the control program 10 in the example 1. The processor 101 of the test instruction sequence generating apparatus 100 executes, e.g., processes in FIG. 11 according to the control program 10 loaded into the main storage device 102 in an execution-enabled manner. In the following discussion, however, the description is made on the assumption that the control program 10 executes the respective processes.

In step S11, the control program 10 (the register dividing unit 11) generates the register dividing table 22 on the basis of the “division count” and the “start register arithmetic type” of the register dividing information and a “register count” of the test target processor. The control program 10 (the processor 101) executes the process in S11 by way of one example of dividing the registers.

In step S12, the control program 10 (the instruction generating unit 12) generates and stores the test instruction sequence in the instruction sequence storage unit 23. The control program 10 (the processor 101) executes the process in step S12 by way of one example of generating the test instruction.

In step S13, the control program 10 (the register amending unit 13) determines whether or not the SIMD arithmetic operation is specified in the “arithmetic type field” of the test instruction generated in step S12. The control program 10 advances to step S14 if the test instruction indicates the SISD arithmetic operation, and advances to step S15 if indicating the SIMD arithmetic operation.

In step S14, the control program 10 (the register amending unit 13) refers to the register dividing table 22, and thus determines whether the register specified in the “result value register field” of the SISD instruction is the register for the SISD arithmetic operation or not. The control program 10 advances to step S16 if the register is the register for the SIMD arithmetic operation and advances to step S18 if being the register for the SISD arithmetic operation.

In step S15, the control program 10 (the register amending unit 13) refers to the register dividing table 22 and thus determines whether the register specified in the “input value register field” of the SIMD instruction is the register for SIMD arithmetic operation or not. For simplifying the verifying process, in the case of amending also the “result value register field”, the control program 10 (the register amending unit 13) may determine whether the register specified in the “result value register field” is the register for the SIMD arithmetic operation or not. The control program 10 advances to step S17 if the register is the register for the SISD arithmetic operation and advances to step S18 if being the register for the SIMD arithmetic operation.

In step S16, the control program 10 (the register amending unit 13) amends the register for the SIMD arithmetic operation, which is specified in the “result value register field” of the SISD instruction, to the register for the SISD arithmetic operation. The control program 10 (the processor 101) executes the process in step S16 by way of one example of amending the register.

In step S17, the control program 10 (the register amending unit 13) amends the register for the SISD arithmetic operation, which is specified in the “input value register field” of the SIMD instruction, to the register for the SIMD arithmetic operation. For simplifying the verifying process, in the case of amending also the “result value register field”, the register for the SISD arithmetic operation, which is specified in the “result value register field”, may be amended to the register for the SIMD arithmetic operation. The control program 10 (the processor 101) executes the process in step S17 by way of one example of amending the register.

In step S18, the control program 10 (the register amending unit 13) determines whether the generation of the instruction sequence is completed or not. This determination can be made by previously setting, in a program, a condition that a designated number of instructions are to be generated, a condition that a test satisfying a predetermined condition is to be performed, and so on. Moreover, this determination can be also made by receiving information needed for determining whether the generation of the instruction sequence is completed or not through the input unit 103. If the generation of the instruction sequence is not yet completed, the control program 10 loops back to step S12 and repeats the processes from step S12 to step S18 till the generation of the instruction sequence is completed. When the generation of the instruction sequence is completed, the control program 10 terminates the test instruction sequence generating process.

In the example 1, the test instruction sequence generating apparatus 100 generates the register dividing table 22 on the basis of the register dividing information. The test instruction sequence generating apparatus 100 divides, with the generation of the register dividing table 22, the registers into the first register group and the second register group, and allocates the 2-group registers to the SISD arithmetic operation and the SIMD arithmetic operation respectively. The test instruction sequence generating apparatus 100 refers to the register dividing table 22 and is thereby enabled to amend the registers specified by the test instruction so that the generated test instruction uses the registers corresponding to the arithmetic type. As a result, it does not happen that the register with its value becoming the indefinite value is employed as the input value register for the SIMD instruction. It is therefore feasible to execute the test instruction sequence by use of the ensured values of the registers and to check the test result.

Further, the registers used for the test instruction are amended in a way that compares the instruction generated by the random numbers with the register dividing table 22. If the register specified by the instruction generated by the random numbers is not the register for the arithmetic type of the instruction, this register is amended to the register for the arithmetic type of the instruction by inverting the bit given in the register field. Accordingly, the register corresponding to the arithmetic type can be specified through simple operations such as comparing with the register dividing table 22 and inverting the bit.

### Second Working Example

The example 1 discussed above is the example in which the processor 101 generates the test instruction sequence for the specified piece of register dividing information.

By contrast with this, a second working example (example 2) exemplifies an instance in which the processor 101 generates the test instruction sequence for plural pieces of register dividing information. In the example 2, the register dividing unit 11 updates the register dividing information, and changes a way of how the registers are grouped. For instance, when the register dividing unit 11 changes the “start register arithmetic type” of the register dividing information from the SISD arithmetic operation to the SIMD arithmetic operation, the registers classified so far into the register group for the SISD arithmetic operation are to be classified into the register group for the SIMD arithmetic operation. In this instance, it follows that the registers of the element 1, which are not used for the SISD arithmetic operation, are employed because of their being classified into the register group for the SIMD arithmetic operation and can be therefore set as the test targets. Thus, the processor 101 generates the test instruction sequence for the plural pieces of register dividing information, thereby enabling the registers to be set as the test targets in an all-encompassing manner.

The hardware architecture of the test instruction sequence generating apparatus 100 in the example 2 is the same as in the example 1, and hence a description thereof is omitted.

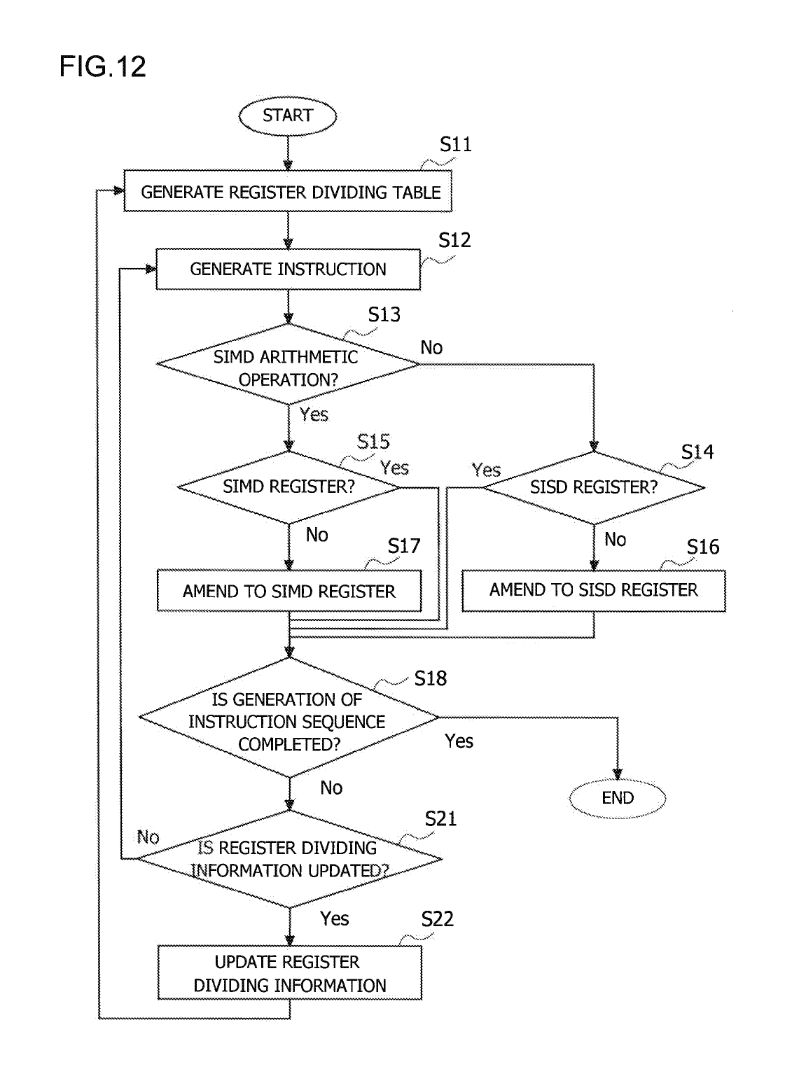

FIG. 12 is a flowchart depicting a processing procedure of generating the test instruction sequence of the control program 10 in the example 2. Steps S11 through S18 are the same as those in the example 1, and their explanations are therefore omitted.

In step S18, if the generation of the instruction sequence is not yet completed, the control program 10 advances to step S21. If the generation of the instruction sequence is completed, the control program 10 finishes the test instruction sequence generating process.

In step S21, the control program 10 (the instruction generating unit 12) determines whether the register dividing information is updated or not. This determination can be made based on whether the tests are performed for all pieces of register dividing information to be set as the test targets or not. The register dividing information to be set as the test targets may be specified beforehand in the program and may also be received through the input unit 103. The control program 10 loops back to step S12 if not updating the register dividing information but advances to step S22 whereas if updating.

In step S22, the control program 10 (the register dividing unit 11) updates the register dividing information and loops back to step the process in step S11. The control program 10 (the processor 101) executes the process in step S22 by way of one example of changing the register group allocated to between the first instruction and the second instruction. Moreover, the control program 10 (the processor 101) executes the process in step S22 by way of one example of changing a count of consecutive register numbers in combinations of the register numbers of the registers contained in the first register group and the second register group.

For example, the register dividing unit 11 updates the “start register arithmetic type” of the register dividing information, thus changing the classification of the register group. To be specific, this implies changing the register group allocated to between the normal instruction and the SIMD instruction, respectively. As a result, such a case occurs that the registers classified so far into the register group for the SISD arithmetic operation are classified into the register group for the SIMD arithmetic operation. Further, such a case occurs that the registers classified so far into the register group for the SIMD arithmetic operation are classified into the register group for the SISD arithmetic operation. Accordingly, the registers can be set as the test targets in the all-encompassing manner by repeating the update of the register dividing information and changing the classification of the register group.

Moreover, e.g., the register dividing unit 11 updates the “division count” of the register dividing information. Changed consequently is the count of the consecutive register numbers in the combinations of the register numbers of the registers contained in the register group for the SISD arithmetic operation and the register group for the SIMD arithmetic operation. For example, when the division count is “2”, as in FIG. 8, with respect to the element 0, the register numbers starting with the register 0 and ending with the register 31 are consecutively grouped for the SISD arithmetic operation, while the register numbers starting with the register 32 and ending with the register 63 are consecutively grouped for the SIMD arithmetic operation. Further, with respect to the element 1, the register numbers starting with the register 64 and ending with the register 95 are consecutively grouped for the SISD arithmetic operation, while the register numbers starting with the register 96 and ending with the register 127 are consecutively grouped for the SIMD arithmetic operation. Furthermore, e.g., when the division count is “4”, as in FIG. 9, with respect to the element 0, the register numbers are consecutively grouped such as the registers 0-15 and the registers 32-47 for the SIMD arithmetic operation. Further, with respect to the element 0, the register numbers are consecutively groups such as the registers 16-31 and the registers 48-63 for the SISD arithmetic operation. Moreover, with respect to the element 1, the register numbers are consecutively grouped such as the registers 64-79 and the registers 96-111 for the SIMD arithmetic operation. Further, with respect to the element 1, the register numbers are consecutively groups such as the registers 80-95 and the registers 112-127 for the SISD arithmetic operation. Thus, the count of the register numbers, which are consecutively allocated to the respective register groups, can be changed by changing the division count. Hence, a variety of register allocations are attained.

### Third Working Example

The examples 1 and 2 given above have discussed the instance in which the processor 101 generates the test instruction sequence. In contrast to this, a third working example (example 3) discusses an example in which the processor 101 executes, after generating the test instruction sequence, the generated test instruction sequence and tests the processor 101 itself.

Hardware architecture of an information processing apparatus 200 in the example 3 is the same as the hardware architecture of the test instruction sequence generating apparatus 100 in the example 1, and hence the description thereof is omitted.

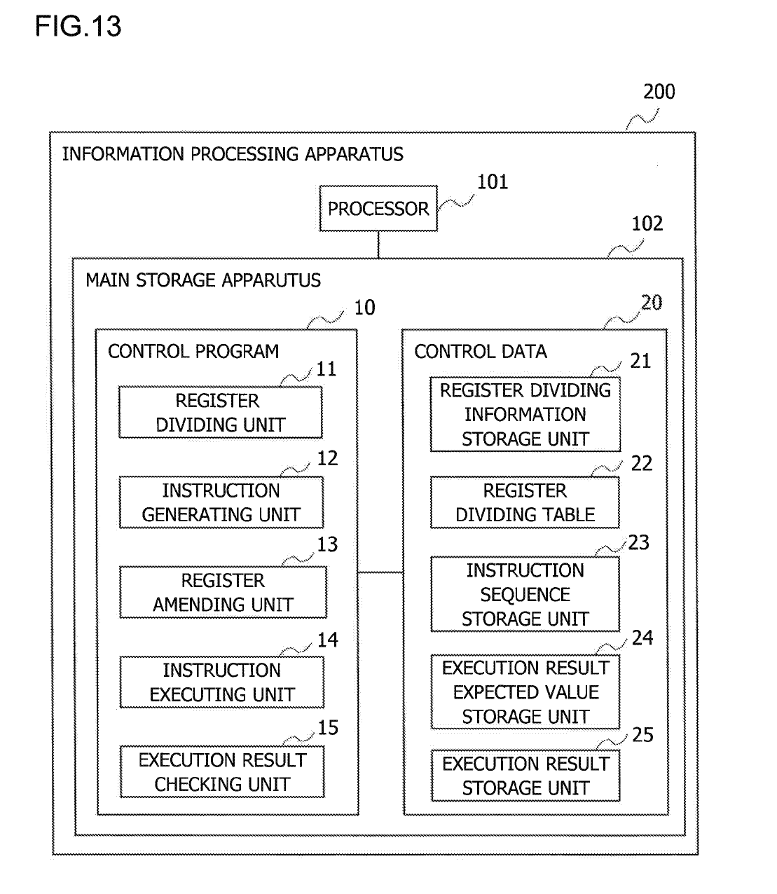

FIG. 13 is a diagram of functional blocks of the information processing apparatus 200 in the example 3. In addition to the architecture of the test instruction sequence generating apparatus 100 in the example 1, the control program 10 in the example 3 further includes an instruction executing unit 14 and an execution result checking unit 15. The control data 20 further includes an execution result expected value storage unit 24 and an execution result storage unit 25.

The instruction executing unit 14 executes the instruction stored in the instruction sequence storage unit 23.

The execution result checking unit 15, when an execution count of the instruction sequence is the first time, stores the execution result in the execution result expected value storage unit 24. The execution result checking unit 15, when the execution count is from the second time onward, checks the execution result against an execution result expected value stored in the execution result expected value storage unit 24, and stores a check result in the execution result storage unit 25.

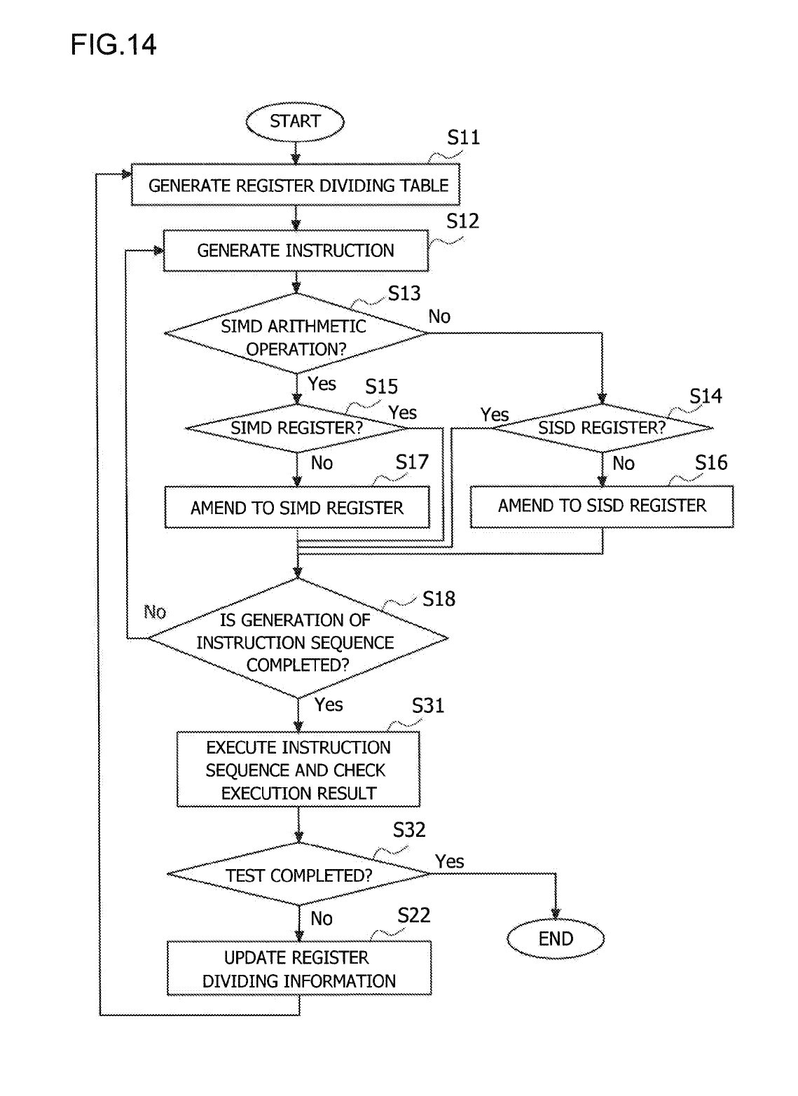

FIG. 14 is a flowchart illustrating a test processing procedure of the control program 10 in the example 3. Steps S11 through S18 are the same as those in the example 1, and their explanations are therefore omitted.

In step S18, if the generation of the instruction sequence is not yet completed, the control program 10 loops back to step S12 and repeats the processes in steps S12 through S18 till completing the generation of the instruction sequence. If the generation of the instruction sequence is completed, the control program 10 advances to step S31.

In step S31, the control program 10 (the instruction executing unit 14) executes the instruction stored in the instruction sequence storage unit 23. Further, the control program 10 (the execution result checking unit 15), when the execution count of the instruction sequence is the first time, stores the execution result in the execution result expected value storage unit 24. When the execution count is from the second time onward, the control program 10 (the execution result checking unit 15) checks the execution result against the execution result expected value stored in the execution result expected value storage unit 24, and stores the check result in the execution result storage unit 25. The control program 10 (the execution result checking unit 15) can executes the instruction sequence an arbitrary number of times and can check the execution results against the execution result expected value. The control program 10 (the execution result checking unit 15), when finishing the execution of the instruction sequence and the check of the execution result, advances to step S32.

In step S32, the control program 10 determines whether the test is completed or not. This determination can be made by previously setting a condition of whether the execution results of a specified execution count are acquired or not, a condition of whether the test satisfying a predetermined condition is performed or not, and so on. Moreover, this determination can be also made by receiving, through the input unit 103, information used for determining whether the test is completed or not. If the test is not yet completed, the control program 10 advances to step S22. Whereas if completed, the control program 10 finishes a testing process. At this time, the control program 10 can output the execution result through the output unit 104, can write the execution result to the auxiliary storage device or the portable recording medium, and can display the execution result on the liquid crystal display etc.

### Modified Example

A modified example of the example 3 exemplifies an instance of setting a processor of another information processing apparatus 200a as a test target.

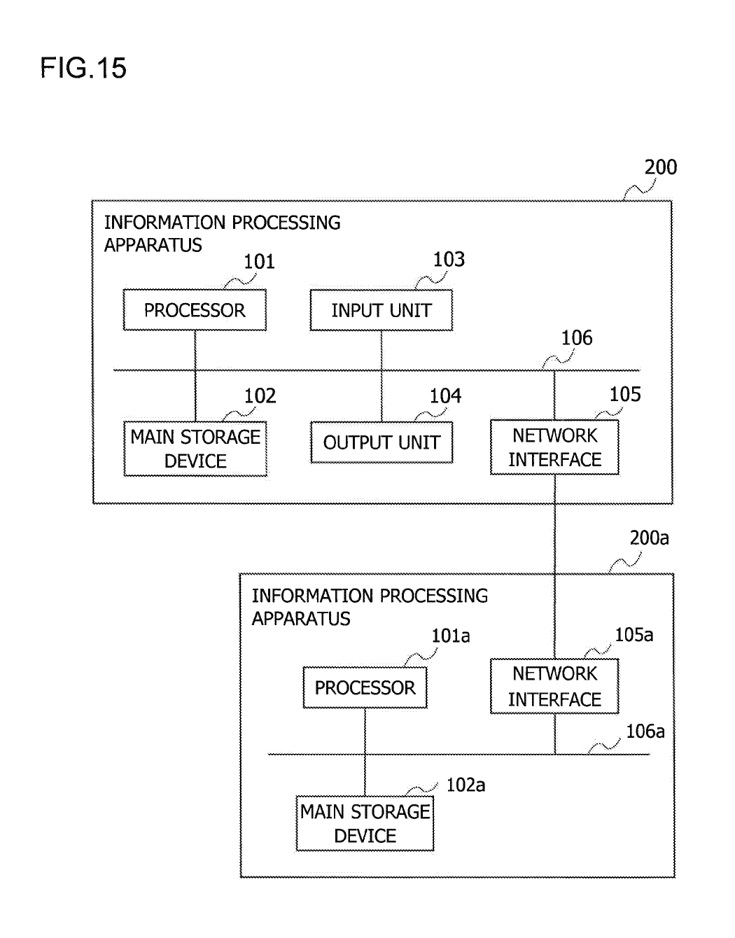

FIG. 15 is a diagram of hardware architecture of an information processing apparatus 200 and hardware architecture of the information processing apparatus 200a set as the test target in the modified example of the example 3.

The information processing apparatus 200 includes, e.g., a network interface 105 in addition to the hardware architecture of the test instruction sequence generating apparatus 100 in the example 1. A description of the same architecture as the test instruction sequence generating apparatus 100 has, is omitted.

The information processing apparatus 200 performs the test for the processor 101a of the test target information processing apparatus 200a via the network interface 105. To begin with, the information processing apparatus 200 transmits the generated test instruction sequence to the test target information processing apparatus 200a. Next, the test target information processing apparatus 200a writes the test instruction sequence transmitted from the information processing apparatus 200 to the instruction sequence storage unit 23 of a main storage device 102a, and stores a write address of each test instruction sequence. Then, the test target information processing apparatus 200a controls the test target processor 101a to read and execute the test instruction sequence written to the main storage device 102a.

The test target information processing apparatus 200a has the processor 101a, the main storage device 102a and a network interface 105a, which are connected to each other via a bus 106a.

The main storage device 102a stores a control program 10a for executing the test instruction sequence generated by the information processing apparatus 200. The processor 101a reads the control program 10a from the main storage device 102a and executes the readout control program 10a. It may be sufficient that, e.g., a branch instruction (RETURN instruction, unconditional JUMP, etc.) to branch to the instruction executing unit 14 of the control program 10a is set to a tail of each test instruction sequence stored in the instruction sequence storage unit 23. On the other hand, the instruction executing unit 14 may execute the branch instruction (to the write address described above) to branch to each test instruction sequence stored in the instruction sequence storage unit 23.

Note that the control program 10a has no necessity for being stored in the main storage device 102a. For instance, the control program 10a can be stored on the portable recording medium such as the CD-ROM, the DVD and the USB memory. The test target information processing apparatus 200a may read the control program 10a from the portable recording medium into the main storage device 102a and may then execute the readout control program 10a.

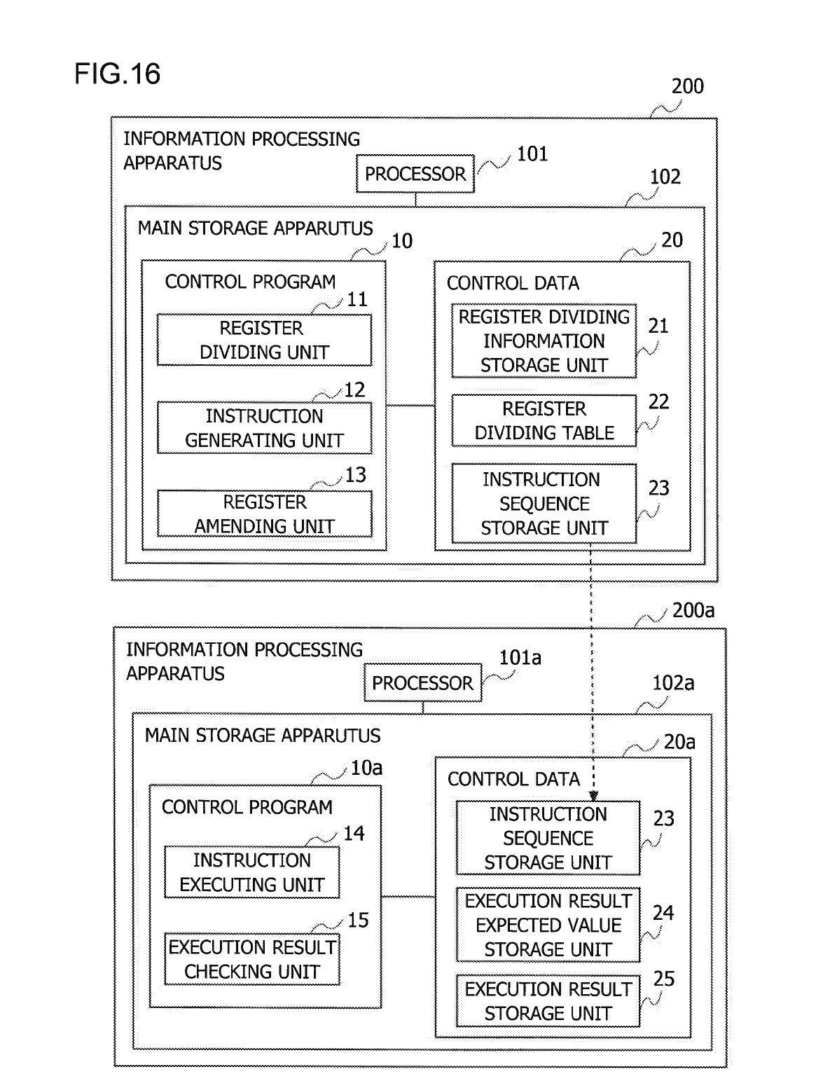

FIG. 16 is a diagram of functional blocks of the information processing apparatus 200 and another information processing apparatus 200a in the modified example of the example 3. The information processing apparatus 200 is the same as the test instruction sequence generating apparatus 100, and hence a description thereof is omitted.

The control program 10a of the test target information processing apparatus 200a includes the instruction executing unit 14 and the execution result checking unit 15. Further, control data 20a of the test target information processing apparatus 200a includes the instruction sequence storage unit 23, the execution result expected value storage unit 24 and the execution result storage unit 25. Functions of the instruction executing unit 14, the execution result checking unit 15, the execution result expected value storage unit 24 and the execution result storage unit 25 are the same as those in the example 3, and therefore their explanations are omitted. The instruction sequence storage unit 23 stores the test instruction sequence written to the main storage device 102a when the test instruction sequence is transmitted from the information processing apparatus 200.

The test processing procedure in the modified example of the example 3 is the same as the procedure in the example 3, and its description is therefore omitted.

In the example 3, the processor 101 executes the test instruction sequence generated by the processor itself and checks the execution result. As for the generated test instruction sequence, the register is amended to use the register corresponding to the arithmetic type, and hence, even in the case of the instruction sequence containing the SISD instructions and the SIMD instructions in mixture, after executing the test instruction sequence by use of the ensured value of the register, the rest result can be thus checked.

Further, in the modified example, the test instruction sequence generated by the information processing apparatus 200 is executed by the processor 101a in the test target information processing apparatus 200a. Thus, the generated test instruction sequence is written to the main storage device readable by the test target processor via the network or the portable recording medium etc. and can be executed by the test target processor. Namely, it is feasible to test the processor other than the processor that generates the test instruction sequence.

The method of the disclosure enables the test to be performed in a way that ensures the value of the register even in the instruction sequence containing the SISD instructions and the SIMD instructions in mixture.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A test instruction sequence generating method for a computer to generate a test instruction sequence for a processor executing a first instruction to make at least a value of a second register an indefinite value when rewriting a first register and executing a second instruction to access a plurality of registers when performing a single execution, the test instruction sequence generating method comprising:
classifying registers used for executing test instructions into two register groups so that a first register and a second register associated therewith are contained in the same register group, allocating registers of a first register group to the first instruction, allocating registers of a second register group, with a value of the second register not becoming an indefinite value due to the first instruction, to the second instruction, and thus dividing the registers;
generating a test instruction executed by the processor; and
amending a register specified in a result value register field of the test instruction to a register of the first register group when the first instruction is specified in an arithmetic type field of the test instruction and a register of the second register group is specified in the result value register field of the test instruction, and further amending a register specified in a input value register field of the test instruction to a register of the second register group when the second instruction is specified in the arithmetic type field of the test instruction and a register of the first register group is specified in the input value register field of the test instruction.

2. The test instruction sequence generating method according to claim 1, further comprising:
changing the register groups, of which the registers are allocated to the first instruction and the second instruction respectively, between the first instruction and the second instruction; and
repeating the generating the test instruction and the amending the register.

3. The test instruction sequence generating method according to claim 1, further comprising:
changing, with the registers being identified by register numbers, a count of the consecutive register numbers in combinations of the register numbers of the registers contained respectively in the first register group and the second register group.

4. A non-transitory computer-readable recording medium having stored therein a program for causing a computer to execute a test instruction sequence generating process of generating a test instruction sequence for a processor executing a first instruction to make at least a value of a second register an indefinite value when rewriting a first register and executing a second instruction to access a plurality of registers when performing a single execution, the test instruction sequence generating process comprising:
classifying registers used for executing test instructions into two register groups so that a first register and a second register associated therewith are contained in the same register group, allocating registers of a first register group to the first instruction, allocating registers of a second register group, with a value of the second register not becoming an indefinite value due to the first instruction, to the second instruction, and thus dividing the registers;
generating a test instruction executed by the processor; and
amending a register specified in a result value register field of the test instruction to a register of the first register group when the first instruction is specified in an arithmetic type field of the test instruction and a register of the second register group is specified in the result value register field of the test instruction, and further amending a register specified in a input value register field of the test instruction to a register of the second register group when the second instruction is specified in the arithmetic type field of the test instruction and a register of the first register group is specified in the input value register field of the test instruction.

5. A test instruction sequence generating apparatus of generating a test instruction sequence for a processor executing a first instruction to make at least a value of a second register an indefinite value when rewriting a first register and executing a second instruction to access a plurality of registers when performing a single execution, the test instruction sequence generating apparatus comprising:
a register dividing unit configured to classify registers used for executing test instructions into two register groups so that a first register and a second register associated therewith are contained in the same register group, allocate registers of a first register group to the first instruction, allocate registers of a second register group, with a value of the second register not becoming an indefinite value due to the first instruction, to the second instruction, and thus divide the registers;
an instruction generating unit configured to generate a test instruction executed by the processor; and
a register amending unit configured to amend a register specified in a result value register field of the test instruction to a register of the first register group when the first instruction is specified in an arithmetic type field of the test instruction and a register of the second register group is specified in the result value register field of the test instruction, and further amend a register specified in a input value register field of the test instruction to a register of the second register group when the second instruction is specified in the arithmetic type field of the test instruction and a register of the first register group is specified in the input value register field of the test instruction.

6. An information processing apparatus of generating a test instruction sequence for a processor executing a first instruction to make at least a value of a second register an indefinite value when rewriting a first register and executing a second instruction to access a plurality of registers when performing a single execution, the information processing apparatus comprising:
a register dividing unit configured to classify registers used for executing test instructions into two register groups so that a first register and a second register associated therewith are contained in the same register group, allocate registers of a first register group to the first instruction, allocate registers of a second register group, with a value of the second register not becoming an indefinite value due to the first instruction, to the second instruction, and thus divide the registers;
an instruction generating unit configured to generate a test instruction executed by the processor;
a register amending unit configured to amend the register specified in a result value register field of the test instruction to a register of the first register group when the first instruction is specified in an arithmetic type field of the test instruction and a register of the second register group is specified in the result value register field of the test instruction, and further amend a register specified in a input value register field of the test instruction to a register of the second register group when the second instruction is specified in the arithmetic type field of the test instruction and a register of the first register group is specified in the input value register field of the test instruction; and
an instruction executing unit configured to make the processor execute the test instruction amended by the amending unit.
